(19) United States
(12) Patent Application Publication
(10) Pub. No.: US 2004/0178266 A1
(43) Pub. Date: Sep. 16, 2004

(54) Card reader display for cars

(75) Inventor: Chung-Wu Chia, Chung Ho City (TW)

Correspondence Address: TROXELL LAW OFFICE PLLC, 5205 LEESBURG PIKE, SUITE 1404, FALLS CHURCH, VA, 22041, US

(73) Assignee: RIGHTECH CORPORATION ., Taipei (TW)

(21) Appl. No.: 10/385,485

(22) Filed: Mar. 12, 2003

(51) Int. Cl. G06K 7/00; G06K 7/10

(52) U.S. Cl. 235/439

(57) ABSTRACT

The card reader display for cars is provided in the main body thereof with a card reading circuit connecting with a display driving circuit, the main body has a memory card connecting portion for insertion and positioning of a memory card, and for forming electric connection between the memory card and the card reading circuit. A display panel is connected with the display driving circuit; the display driving circuit also is connected with a function selection controller which has a key on the main body for operation of a user to control the operation mode of the display. In this way, the abovementioned members are integrated to form a card reader display for cars capable of reading, restoring and playing the interior image and literal data of a memory card.

### BACKGROUND OF THE INVENTION

1. Field of the Invention

The present invention is related to a card reader display for cars, and especially to such a card reader display for cars capable of reading, restoring and playing the interior image and literal data of a memory card (including one of ATA memory cards, CF memory cards, SM card, MMC card, MS cards, SD card and XD cards), it is different from the conventional mode of image playing only with the image signal source provided by a VCR, a VCD or a DVD used normally for cars; and can play the data taking memory cards as their storage.

2. Description of the Prior Art

A display used on a car, conventionally, takes a VCR, a VCD or a DVD as its image signal source, with which, the image data must be read via a device such as an image player, an image CDROM etc., the signals read by the device then are displayed on a display; this mode of image playing limits the storage of data to a VCR, a VCD or a DVD, and can not meet the image storing style required nowadays.

Particularly, a conventional display for cars must have image data read via an image player or an image CDROM etc., the cost of equipment purchasing is increased by that the aforesaid devices occupy a large space in a car; and the conventional equipment for reading image data from a VCR, a VCD or a DVD makes data reading with a magnetic head or a reading/writing element, this is more subjected to misreading by the vibration of the car during driving, and even the equipment for reading may be damaged.

### SUMMARY OF THE INVENTION

The card reader display for cars of the present invention is provided in the main body thereof with a card reading circuit connecting with a display driving circuit, the main body has a memory card connecting portion for insertion and positioning of a memory card, and for forming electric connection between the memory card and the card reading circuit. A display panel is connected with the display driving circuit; the display driving circuit also is connected with a function selection controller which has a key on the main body for operation of a user to control the operation mode of the display. In this way, the abovementioned members are integrated to form the card reader display for cars capable of reading, restoring and playing the interior image and literal data of a memory card.

Further, the main body of the display comprises a wireless audio and video signals receiving module, a wireless acoustic frequency signal transmitting module and an image connecting portion all connected with the display driving circuit, so that the display can play the radio signals from a TV station, and send the acoustic frequency signals in a mode such as FM mode to the hi-fi set of the car for playing, this can save the cumbersomeness of line connecting; and the display can be connected with an externally connected image reading equipment such as a conventional video player, an image CDROM etc., to play the image signals read by the externally connected equipment and thereby can increase the function and adaptability of the entire display.

Particularly, the main body of the display comprises an infrared signal receiving module, an infrared signal emitting module both connected with the display driving circuit to respectively receive the signals from a remote control and send the signals of the sound source to an infrared earphone for playing, this thus increases the convenience of use of the display.

The present invention will be apparent in its structural combination and the entire mode of operation thereof after reading the detailed description of the preferred embodiment thereof in reference to the accompanying drawings.

### BRIEF DESCRIPTION OF THE DRAWINGS

FIG. 1 is a perspective view showing the apparent structure of the present invention;

FIG. 2 is a schematic block diagram showing the basic construction of the display of the present invention;

FIG. 3 is a perspective view showing the apparent structure of another embodiment of the present invention;

FIG. 4 is a schematic block diagram showing the basic construction of the display of the other embodiment of the present invention.

### DETAILED DESCRIPTION OF THE PREFERRED EMBODIMENT

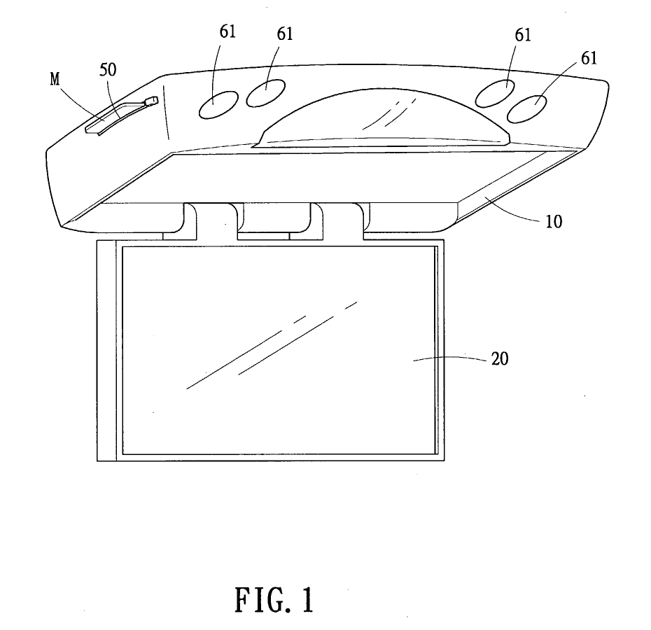

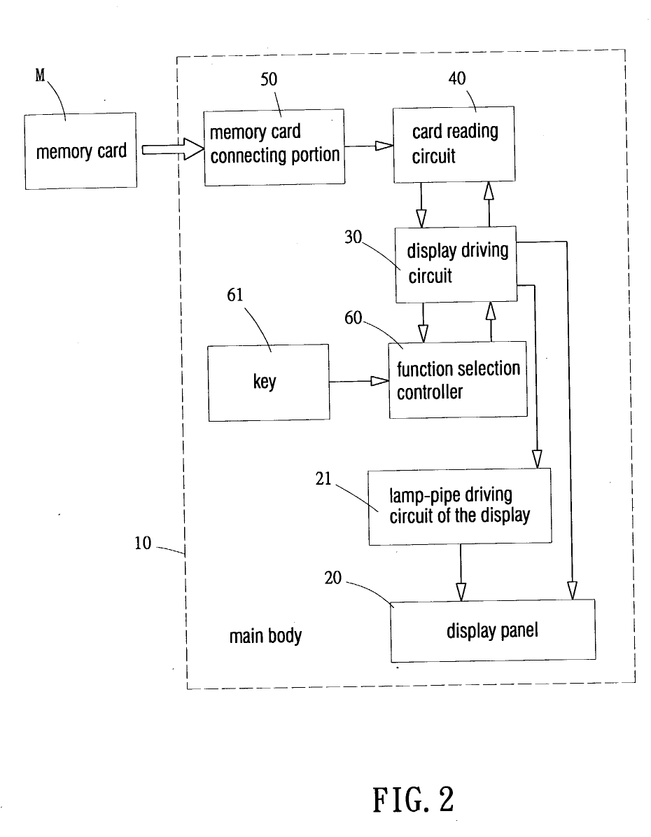

The basic construction of the card reader display for cars of the present invention as shown in FIGS. 1, 2 is comprised of:

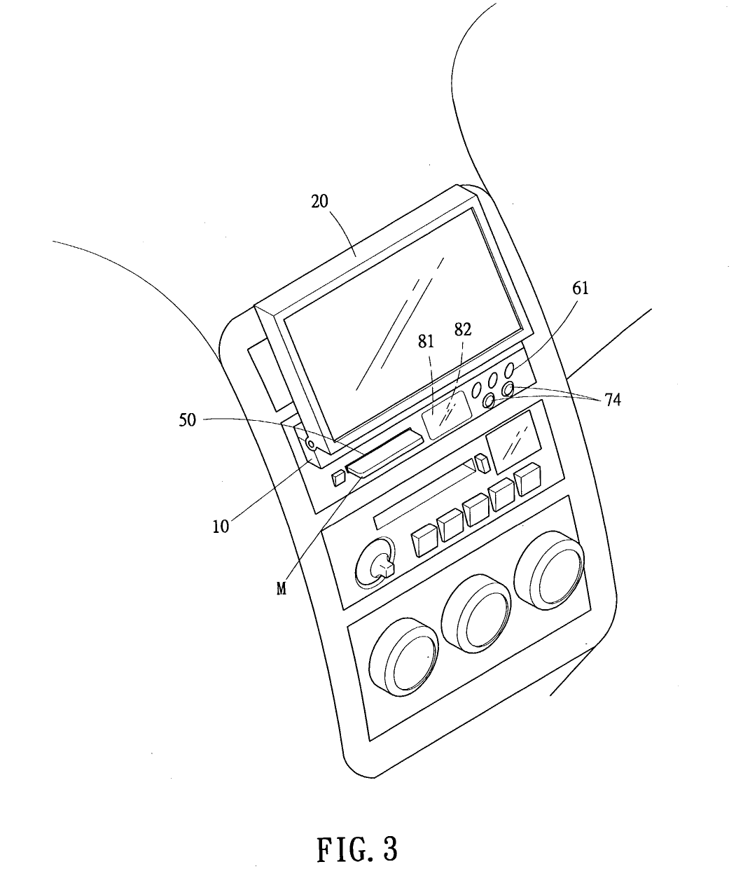

a main body 10 fixedly mounted on the interior structural surface of a car for receiving and mounting members, it is provided with a display panel 20 for displaying image signals, the entire display can have its main body 10 fixedly mounted on the top surface of the car as shown in FIG. 1 or have the main body 10 combined with an instrument in the car as shown in FIG. 3 in dependence upon the practical requirement of the interior of the car;

a display driving circuit 30 provided in the main body 10, being the main operation member of the entire display, to deliver the image signals to the display panel 20 for displaying, the display panel 20 can be of the type of TFTLCD, LTPS, OLED, PLED or DSTN; the display panel 20 shown in this embodiment is a TFTLCD type display panel provided with a lamp-pipe driving circuit 21 of the display;

a card reading circuit 40 provided in the main body 10 and connecting with the display driving circuit 30 for reading the interior data of a memory card M and restoring them to image or literal signals for playing;

a memory card connecting portion 50 provided on the main body 10 for insertion and positioning of the memory card M, and for forming electric connection between the memory card M and the card reading circuit 40;

a function selection controller 60 connected with the display driving circuit 30 and having a key 61 on the main body 10 for operation of a user to control the operation mode of the display.

In this way, the abovementioned members are integrated to form the card reader display for cars capable of reading, restoring and playing the interior image and literal data of the memory card M; this is different from the conventional mode of image playing only with the image signal source provided by a VCR, a VCD or a DVD, and can play the data taking memory card as their storage. Particularly, operation of the display is, the card reading circuit 40 reads the interior data of a memory card M without affecting by the vibration of the car during driving, thereby a better image displaying effect can be obtained, and the equipment for reading is not subjected to damage by the vibration of the car.

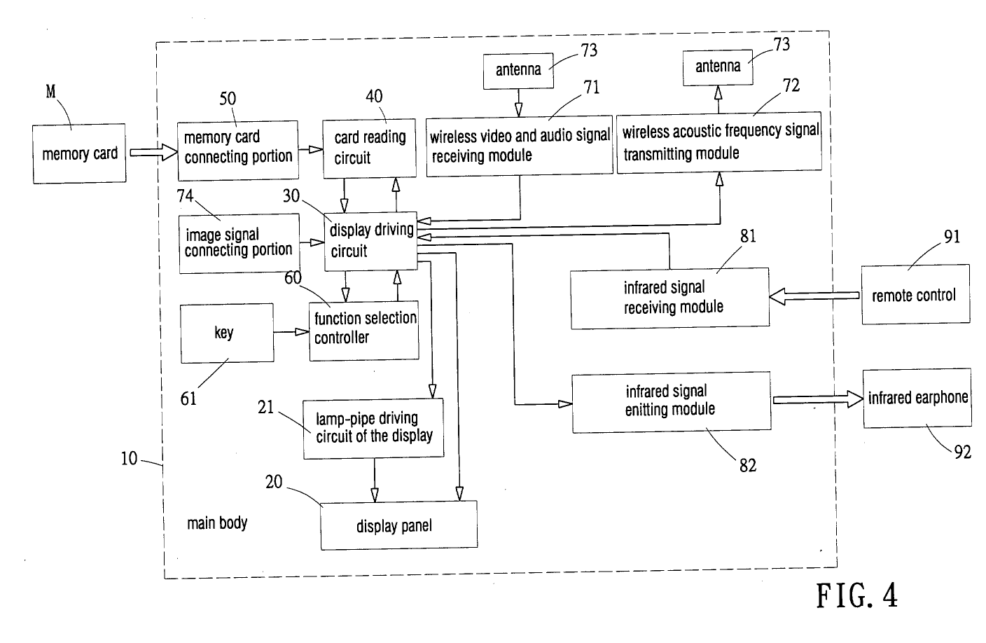

And more, by virtue that image data principally take magnetic tapes, VCD's or DVD's as their storage, the display of the present invention can not only be used to play the data stored in memory cards, but also be provided on the main body 10 thereof with a wireless audio and video signals receiving module 71, a wireless acoustic frequency signal transmitting module 72 and an image connecting portion 74 all connected with the display driving circuit 30 such as are shown in FIGS. 3 and 4. The wireless audio and video signals receiving module 71 and the wireless acoustic frequency signal transmitting module 72 are both provided with an antenna 73; so that the display can play the radio signals from a TV station, and send the acoustic frequency signals in a mode such as FM mode to the hi-fi set of the car for playing through horns, this can save the cumbersomeness of line connecting; and the display can be connected with an externally connected image reading equipment such as the image connecting portion 74, a conventional video player and an image CDROM etc., to play the image signals read by the externally connected equipment and thereby can increase the function and adaptability of the entire display.

Further, the main body 10 of the display can be provided thereon with an infrared signal receiving module 81 and an infrared signal emitting module 82 respectively connected with the display driving circuit 30 to respectively receive the signals from a remote control 91 and send the signals of the sound source to an infrared earphone 92 for playing, this can thus increase the convenience of use of the display.

The card reader display for cars of the present invention provides a better structure and better operation mode of the display for cars capable of playing the interior image and literal data of a memory card. The description and drawings are only for illustrating a preferred embodiment of the present invention, and not for giving any limitation to the scope of the present invention. It will be apparent to those skilled in this art that various modifications or changes in structure and feature without departing from the spirit of this invention shall also fall within the scope of the appended claims of the present invention.

1. A card reader display for cars comprising:
a main body fixedly mounted on an interior structural surface of a car for receiving and mounting members, said main body is provided with a display panel for displaying image signals;
a display driving circuit provided in said main body to deliver said image signals to said display panel for displaying;
a card reading circuit provided in said main body and connecting with said display driving circuit for reading the interior data of a memory card and restoring them to signals for playing;
a memory card connecting portion provided on said main body for insertion and positioning of said memory card, and for forming electric connection between said memory card and said card reading circuit;
a function selection controller connected with said display driving circuit which has a key on said main body for operation of a user to control the operation mode of said display;
in this way, the aforesaid members are integrated to form said card reader display for cars capable of reading, restoring and playing said literal data of said memory card.

2. The card reader display for cars as in claim 1, wherein
said main body is provided with a wireless audio and video signals receiving module, a wireless acoustic frequency signal transmitting module both connected with said display driving circuit, said wireless audio and video signals receiving module and said wireless acoustic frequency signal transmitting module are both provided with an antenna; so that said display is adapted to playing radio signals from a TV station, and send acoustic frequency signals in a mode such as FM mode to a hi-fi set of a car for playing through horns.

3. The card reader display for cars as in claim 1, wherein said main body comprises an image connecting portion connected with said display driving circuit for connecting with an externally connected image reading equipment to play image signals read by said externally connected equipment.

4. The card reader display for cars as in claim 1, wherein said main body comprises an infrared signal receiving module connected with said display driving circuit to receive signals from a remote control.

5. The card reader display for cars as in claim 1, wherein said main body comprises an infrared signal emitting module connected with said display driving circuit to send signals of a sound source to an infrared earphone for playing.
